(19) United States
(12) Patent Application Publication
(10) Pub. No.: US 2026/0369202 A1
(43) Pub. Date: Nov. 19, 2026

(54) Emission Blanking with Dynamic Duty Cycle for Under-Display Sensor

(71) Applicant: Apple Inc., Cupertino, CA (US)

(72) Inventors: Majid Gharghi, San Carlos, CA (US); Chun Lu, San Jose, CA (US); Daniel de Godoy Peixoto, Austin, TX (US); David A Doyle, Needham, MA (US); David S Hum, Sunnyvale, CA (US); Jiayi Jin, Redwood City, CA (US); Pankul Dhingra, San Diego, CA (US); Weijun Yao, Saratoga, CA (US)

(21) Appl. No.: 19/664,689

(22) Filed: Apr. 30, 2026

Related U.S. Application Data
(60) Provisional application No. 63/805,861, filed on May 14, 2025.

(51) Int. Cl. G09G 3/20

(52) U.S. Cl. CPC G09G 3/2007; G09G 2310/063; G09G 2310/066; G09G 2320/0233; G09G 2320/0626

(57) ABSTRACT

A dynamic duty cycle scheme may be implemented to enable, at a first time, a higher duty cycle to reduce lifetime burn-in and enable, at a second time, a lower duty cycle to enable under-display sensing while reducing or eliminating crosstalk between the display pixels and the under-display sensor.

### CROSS-REFERENCE TO RELATED APPLICATIONS

This application claims priority to U.S. Provisional Patent Application No. 63/805,861 entitled “Emission Blanking with Dynamic Duty Cycle for Under-Display Sensor,” filed on May 14, 2025, which is hereby incorporated by reference in its entirety for all purposes.

### SUMMARY

The present disclosure relates to operation of an under-display sensor disposed beneath an electronic display. In particular, adjusting a duty cycle of display pixels of the electronic display to reduce or eliminate crosstalk between the electronic display and the under-display sensor.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Numerous electronic devices — such as computers, mobile phones, portable media devices, tablets, televisions, virtual-reality headsets, and vehicle dashboards, among many others — often include electronic displays. To display an image, an electronic display may control light emission of its display pixels based on corresponding image data for the display pixels. By emitting light in various brightness values at different display pixels according to the image data, the electronic display may present an image.

In some instances, it may be beneficial for an under-display sensor to operate during normal operation of the electronic device (e.g., while a user is making a call, streaming audio and/or video content, sending text messages, and so on). However, during normal operation of the electronic device there may be crosstalk between the display panel and the under-display sensor due to reflection of light emitted from display pixels and reflected from the display panel towards the under-display sensor, back-emission of light emitted from the display pixels, or both. Time-multiplexing may be implemented to enable sensing (e.g., activation of the under-display sensor) when there is no emission from the electronic display. This time-multiplexing scheme may be achieved via a pulse-width modulation (PWM) pixel scheme where the electronic display emission is enabled (emission-on) for a portion of the frame and disabled (emission-off) for another portion of the frame. The electronic display may operate at a duty cycle (e.g., 80%) that is too high (e.g., is too frequently emitting) to enable the under-display sensor to perform sensing without excessive crosstalk. To achieve enough emission-off time to perform sensing while reducing or eliminating crosstalk, a lower duty cycle (e.g., 50%) may be implemented. However, the low duty cycle may degrade lifetime burn-in performance of the electronic display. The higher duty cycle (e.g., 80%) may be suitable to reduce pixel burn-in, but may not afford enough time for camera sensing, and the camera may pick up a greater amount of crosstalk at the higher duty cycle than it would at the lower duty cycle.

Accordingly, a dynamic duty cycle scheme may be implemented to enable, at a first time, a higher duty cycle to reduce lifetime burn-in and enable, at a second time, a lower duty cycle to enable under-display sensing while reducing or eliminating crosstalk between the display pixels and the under-display sensor. The dynamic duty cycle scheme may gradually (e.g., progressively) transition from the higher duty cycle scheme to the lower duty cycle scheme and vice versa in a manner that conceals the change in duty cycle from the user. For example, the duty cycle may change by a unit amount per-image frame. The gradual transition may be imperceptible to the human eye. Moreover, as the duty cycle changes, the brightness may change proportionally. To prevent perceivable brightness change, the brightness (e.g., intensity, emission power) of displayed content may be adjusted in a manner corresponding to the duty cycle change. For example, the gray level associated with the image data programmed into display pixels of the electronic display may be increased or decreased per-image frame to maintain constant (or near-constant) brightness despite the changing duty cycle.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electronic device with an electronic display, in accordance with an embodiment;

FIG. 2 is a front view of a handheld device representing an example of the electronic device of FIG. 1, in accordance with an embodiment;

FIG. 3 is a front view of another handheld device representing another example of the electronic device of FIG. 1, in accordance with an embodiment;

FIG. 4 is a perspective view of a notebook computer representing an example of the electronic device of FIG. 1, in accordance with an embodiment;

FIG. 5 illustrates front and side views of a wearable electronic device representing another example of the electronic device of FIG. 1, in accordance with an embodiment;

FIG. 6 is a block diagram of the electronic display of FIG. 1 with an under-display sensor and display driver circuitry that includes duty cycle control circuitry, in accordance with an embodiment;

FIG. 7 is a flowchart of a method for adjusting, via the emission duty cycle control circuitry, the emission duty cycle of the electronic display to facilitate the operation of the under-display sensor, in accordance with an embodiment;

FIG. 8 is a diagram illustrating a transition of the electronic display from a first emission duty cycle to a second emission duty cycle, in accordance with an embodiment;

FIG. 9 is a flowchart of a method for adjusting image data to compensate for the change in display brightness associated with the adjustment of the emission duty cycle described with respect to FIG. 8, in accordance with an embodiment;

FIG. 10 illustrates the luminance of the electronic display during the low duty cycle stage and the high duty cycle stage described with respect to FIG. 8, in accordance with an embodiment; and

FIG. 11 is a diagram illustrating a global shutter emission scheme and a steep ramp emission (SRE) scheme, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Dynamic duty cycle systems and methods are described herein that may reduce or eliminate crosstalk between an under-display sensor and an electronic display of an electronic device. In some instances, it may be beneficial for the under-display sensor to operate during normal operation of the electronic device (e.g., while a user is making a call, streaming audio and/or video content, sending text messages). However, during operation of the electronic device, there may be crosstalk between the display panel and the under-display sensor due to reflection, back-emission, or both. Reflection may refer to light emitted from display pixels of the electronic display, reflected off of the display panel back towards the under-display sensor and detected by the under-display sensor. Back-emission may refer to light emitted from the display pixels and unintentionally detected by the under-display sensor below the under-display sensor in scenarios in which the under-display sensor is below (e.g., behind) the display pixels. The under-display sensor may be designed to capture information about the environment outside of the electronic device. The under-display sensor, for example, may be an under-display camera that captures images during non-emission periods for context awareness or augmented reality applications. Consequently, reflection and/or back-emission of the display pixels may interfere with the camera sensing, impairing the ability of the under-display sensor to accurately sense the environment.

Time-multiplexing may be implemented to enable sensing (e.g., activation of the under-display sensor) when there is no emission from the electronic display. This time-multiplexing scheme may be achieved via a pulse-width modulation (PWM) pixel scheme where the electronic display emission is enabled (emission-on) for a portion of the frame and disabled (emission-off) for another portion of the frame. That is, the under-display sensor may be programmed (e.g., instructed via processing circuitry) to operate (e.g., capture an image) during the emission-off period to reduce or eliminate the interfering light (e.g., crosstalk) being emitted from the display pixels. To achieve enough emission-off time to perform sensing while reducing or eliminating crosstalk, a relatively lower duty cycle (e.g., 50%) may be implemented. However, a low duty cycle may degrade lifetime burn-in performance of the electronic display. A relatively higher duty cycle (e.g., 80%) may be suitable for normal operation to reduce pixel burn-in, but may not afford enough time for sensing via the under-display sensor, and the under-display sensor may detect a greater amount of crosstalk at the higher duty cycle than it would at the lower duty cycle.

Accordingly, a dynamic duty cycle scheme may be implemented to enable, at a first time, a higher duty cycle to reduce lifetime burn-in and enable, at a second time, a lower duty cycle to enable under-display sensing while reducing or eliminating crosstalk between the display pixels and the under-display sensor. To transition from the higher duty cycle to the lower duty cycle, the duty cycle may be gradually walked down (e.g., by 1%) per image frame until the target duty cycle (e.g., 50% duty cycle) is reached. Accordingly, it may take approximately 30 frames to walk down the duty cycle from the higher duty cycle during normal operation (e.g., 80% duty cycle) to the lower duty cycle for under-display sensing (e.g., 50% duty cycle). Conversely, to transition from the lower duty cycle to the higher duty cycle, the duty cycle may be gradually walked up (e.g., by 1%) per image frame until the target duty cycle (e.g., 80% duty cycle) is reached.

As the electronic display transitions from the higher duty cycle to the lower duty cycle, the average luminance of the electronic display may decrease proportionally—and may increase proportionally when transitioning from the lower duty cycle to the higher duty cycle. To prevent noticeable and undesirable brightness changes to the content displayed on the electronic display, a gray level of the image data may be adjusted to compensate for the change in duty cycle. Accordingly, as the duty cycle is stepped down from the higher duty cycle to the lower duty cycle, the image data may be adjusted to proportionally increase the brightness of the displayed content. As the duty cycle may be gradually stepped down in each subsequent frame until the target duty cycle is met, the image data may be progressively brightened proportionally for each subsequent frame. Conversely, the image data may be adjusted to progressively and proportionally decrease the brightness as the duty cycle is stepped up from the lower duty cycle to the higher duty cycle.

A rolling emission window may be undesirable for use with the under-display sensor, as the rolling emission window may result in at least a portion of the electronic display being illuminated at all times during display of content. Therefore, when using a rolling emission window, there may be no period of time in which the sensing may be performed without undesirable levels of crosstalk. A global shutter that turns off and turns on all rows of display pixels at the same time may be used to enable the under-display sensor to perform sensing while reducing or eliminating crosstalk. However, the global shutter may result in a large transient current when all rows of display pixels are turned on or turned off simultaneously. Accordingly, a Steep Ramp Emission (SRE) scheme may be implemented during the transition period from emission-off to emission-on or vice versa. The SRE scheme may control the display pixels of the electronic display such that they are not necessarily turned on or off simultaneously, but may be turned on and off progressively so quickly (e.g., near-simultaneously) as to enable under-display sensor operation with reduced or minimized crosstalk while also reducing or minimizing transient current associated with the global-on and global-off emission schemes.

For example, a first transition period from emission-on to emission-off, the display pixels of the electronic display may gradually turn off the display pixels of the electronic display. In a second transition period from emission-off to emission-on, the electronic display may gradually turn on the display pixels of the electronic display to smooth out the inrush current (e.g., transient current) associated with turning on all display pixels of the electronic display simultaneously. In this manner, the SRE scheme may enable the electronic display to decrease or minimize under-display camera crosstalk and to gradually ramp up the display pixels to reduce the inrush current associated with transitioning to the emission-on period.

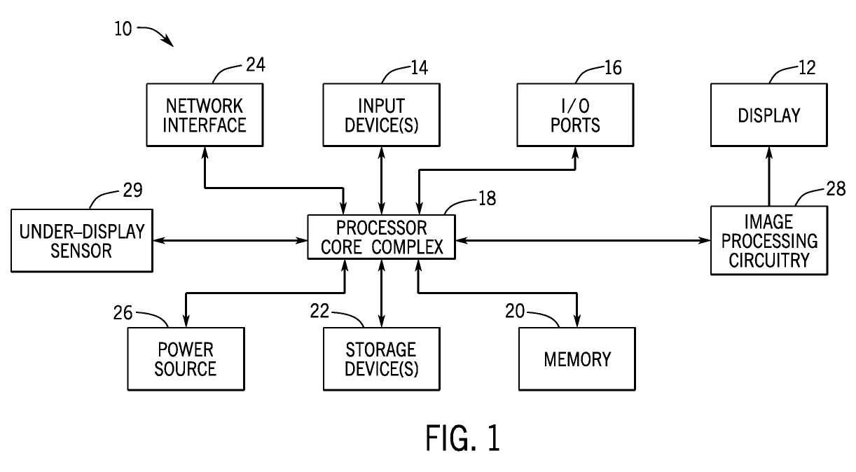

Keeping the foregoing in mind, an electronic device 10 including an electronic display 12 is shown in FIG. 1. FIG. 1 is a block diagram of an electronic device 10 with an electronic display 12. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, a power source 26 (e.g., power supply), image processing circuitry 28, and an under-display sensor 29. The various components described in FIG. 1 may include hardware elements (e.g., circuitry), software elements (e.g., a tangible, non-transitory computer-readable medium storing computer-readable instructions executable by one or more processors), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

The electronic display 12 may include a display panel with an array of display pixels. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one or more color components (e.g., red, green, or blue for an RGB pixel arrangement, red, green, blue, or white for an RGBW arrangement, or a first green component, a red component, a second green component, or a blue component for a GRGB arrangement).

The electronic display 12 may display an image by controlling light emission from its display pixels based on image data associated with corresponding display pixels in the image. In some embodiments, image data may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display frames based on image data generated by the processor core complex 18, or the electronic display 12 may display frames based on image data received via the network interface 24, an input device, or an I/O port 16.

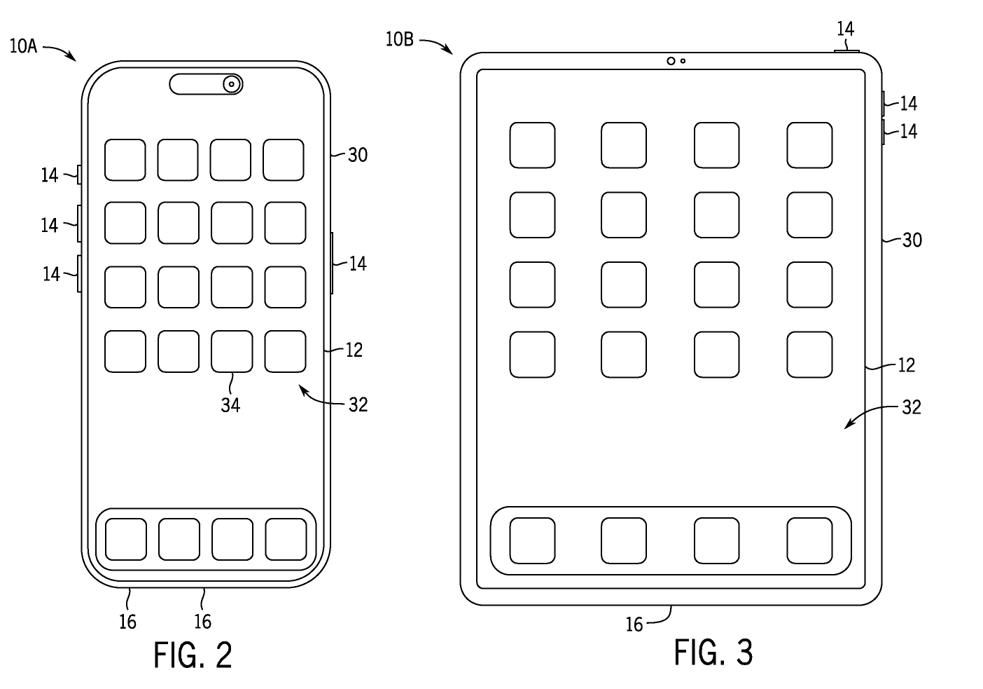

The electronic device 10 may be any suitable electronic device. To help illustrate, an example of the electronic device 10, a handheld device 10A, is shown in FIG. 2. FIG. 2 is a front view of a handheld device representing an example of the electronic device 10 of FIG. 1. The handheld device 10A may be a portable phone, a media player, a personal data organizer, a handheld game platform, or the like. For illustrative purposes, the handheld device 10A may be a smart phone, such as any IPHONE® model available from Apple Inc.

The image processing circuitry 28 may adjust the image data before the image data is sent to the electronic display 12. For example, the image processing circuitry 28 may adjust the image data such that the content to be displayed on the electronic display appears brighter or darker to the user (e.g., by adjusting a gray level associated with the image data). Gray level may refer to an image that takes its values in a gray scale that may include a range of, for example, 0 to 255 for 8-bit images. As will be discussed in greater detail below, the image processing circuitry may dynamically adjust the brightness (e.g., gray level) of the image data based on the emission duty cycle that the electronic display will be utilizing. As used herein, “dynamically” may mean in real-time (or near real-time) as the emission duty cycle utilized by the display is adjusted.

The under-display sensor 29 may include a camera, an ambient light sensor, a proximity sensor, an ambient color sensor, or any other appropriate under-display sensor. It may be beneficial for the under-display sensor 29 to activate (e.g., operate) during normal operation of the electronic device (e.g., while a user is making a call, streaming, sending text messages, and so on). However, during normal operation of the electronic device 10 there may be crosstalk between the display panel and the under-display sensor due to reflection, back-emission, or both. Consequently, it may be beneficial for the under-display sensor 29 to activate during a lower emission duty cycle period of the electronic display 12. The under-display sensor 29 may be coupled to a controller and/or firmware that controls when the under-display sensor 29 is to activate based on an indication of the emission duty cycle at which the electronic display 12 is operating. In some embodiments, the processor core complex 18 or the image processing circuitry 28 may control the under-display sensor 29. Moreover, while the under-display sensor 29 may be configured to activate (e.g., operate, turn-on, capture an image, collect ambient light data, and so on) during the lower emission duty cycle period, in some instances the under-display sensor 29 may be activated (e.g., may operate, turn-on, capture an image, collect ambient light data, and so on) at all times, and the data obtained from the under-display sensor 29 may be captured and stored in memory (e.g., nonvolatile memory) only during the lower emission duty cycle period.

The handheld device 10A includes an enclosure 30 (e.g., housing). The enclosure 30 may protect interior components from physical damage or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

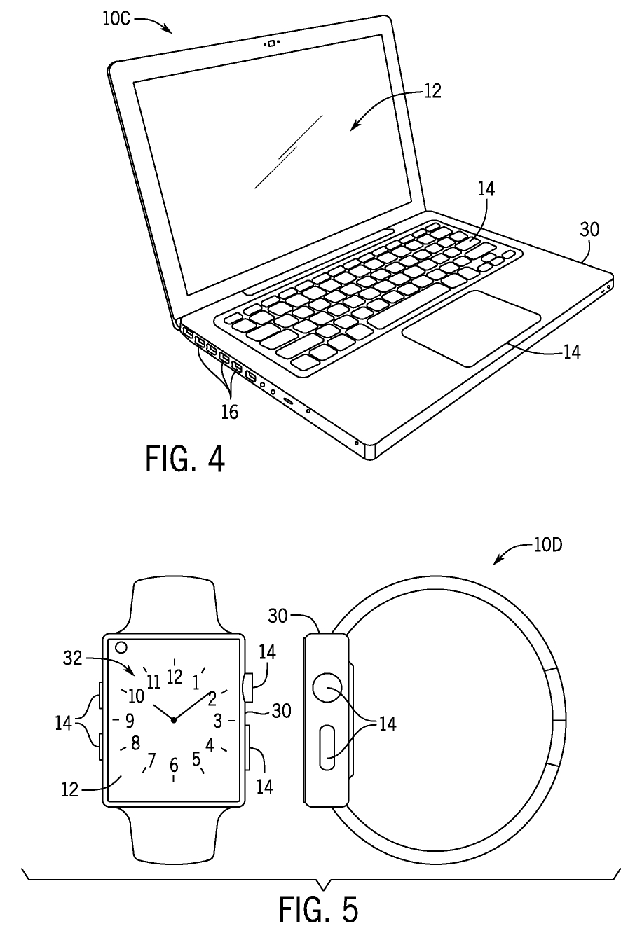

Another example of a suitable electronic device 10, specifically a tablet device 10B, is shown in FIG. 3. FIG. 3 is a front view of another handheld device representing another example of the electronic device 10 of FIG. 1. The tablet device 10B may be any IPAD® model available from Apple Inc. A further example of a suitable electronic device 10, specifically a computer 10C, is shown in FIG. 4. FIG. 4 is a perspective view of a notebook computer representing an example of the electronic device 10 of FIG. 1. For illustrative purposes, the computer 10C may be any MACBOOK® or IMAC® model available from Apple Inc. Another example of a suitable electronic device 10, specifically a watch 10D, is shown in FIG. 5. FIG. 5 illustrates front and side views of a wearable electronic device representing another example of the electronic device 10 of FIG. 1. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

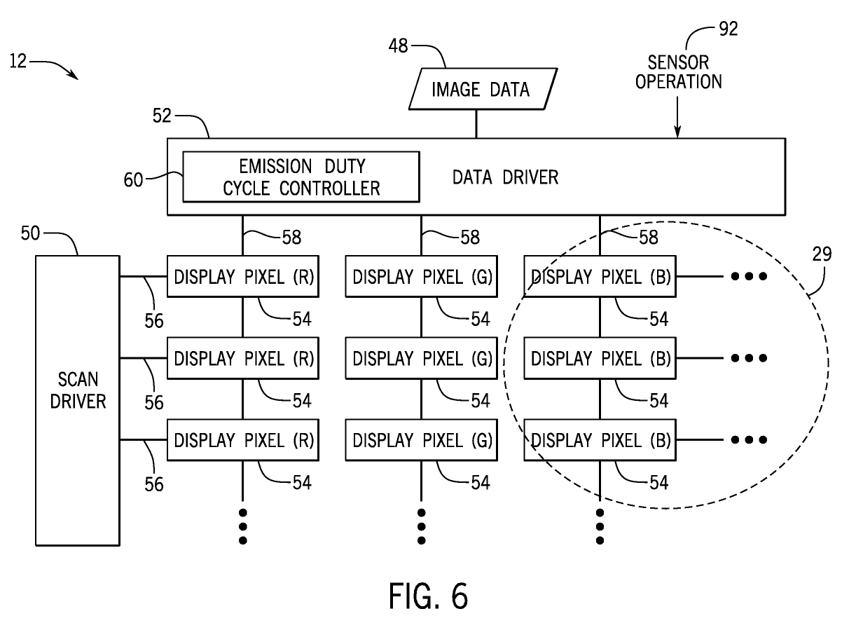

FIG. 6 is a block diagram of the electronic display 12 of FIG. 1 with display driver circuitry that includes emission duty cycle controller 60 circuitry and the under-display sensor 29. In FIG. 6, the electronic display 12 is shown as an electronic display 12 representing a liquid crystal display (LCD) or an organic light emitting diode (OLED) display. The electronic display 12 may receive image data 48 for display. The electronic display 12 uses display driver circuitry that includes scan driver 50 circuitry and data driver 52 circuitry to program the image data 48 onto display pixels 54. The display pixels 54 may each represent a liquid crystal (LC) cell to filter certain colors of light in various brightness levels from a backlight (not shown) or may contain one or more self-emissive elements, such as a light-emitting diodes (LEDs) (e.g., organic light emitting diodes (OLEDs) or micro-LEDs (µLEDs)). The display pixels 54 may also represent pixels of digital mirror devices (DMD) or other suitable display devices that may use pixel grouping. In any event, different display pixels 54 may emit different colors (e.g., red (R), green (G), blue (B), for an RGB display). For example, some of the display pixels 54 may emit red light, some may emit green light, and some may emit blue light. Thus, the display pixels 54 may be driven to emit light at different brightness levels to cause a user viewing the electronic display 12 to perceive an image formed from different colors of light. The display pixels 54 may also correspond to hue and/or luminance levels of a color to be emitted and/or to alternative color combinations, such as combinations that use cyan, magenta, and yellow (CMY), or others.

The scan driver 50 may provide scan signals (e.g., pixel reset, data enable, on-bias stress, scan, data sampling) on scan lines 56 to activate the display pixels 54 by row. For example, the scan driver 50 circuitry may cause one or more selected rows of the display pixels 54 to become enabled to receive a portion of the image data 48 from data lines 58 from the data driver 52. As used herein, the portion of image data 48 received by display pixels 54 may be referred to as “image data” or “pixel data.” An image frame of image data 48, containing pixel data for the display pixels 54, may be programmed onto the display pixels 54 row by row or selected groups of rows.

The under-display sensor 29 may include a camera, an ambient light sensor, a proximity sensor, an ambient color sensor, or any other appropriate under-display sensor. As mentioned previously, it may be beneficial for the under-display sensor 29 to operate during normal operation of the electronic device (e.g., while a user is making a call, streaming, sending text messages, and so on). However, during normal operation of the electronic device 10 there may be crosstalk between the display panel and the under-display sensor due to reflection, back-emission, or both.

Time-multiplexing may be implemented to enable sensing (e.g., activation of the under-display sensor 29) when there is no emission from the electronic display. The under-display sensor 29 may be programmed (e.g., instructed via the processor core complex 18) to operate (e.g., capture an image) during the emission-off period to reduce or eliminate the interfering light (e.g., crosstalk) being emitted from the display pixels 54. In some instances, the display pixels 54 of the electronic display 12 may be emitting at a first duty cycle (e.g., 70% or higher, 80% or higher, 90% or higher, and so on). The first duty cycle may be suitable to reduce pixel burn-in and thus desirable for normal operation of the electronic device 10. However, the first duty cycle may not afford the under-display sensor 29 enough time for camera sensing, ambient light sensing, or any other type of appropriate operation of the under-display sensor 29. That is, at the first (e.g., higher) duty cycle, the electronic display 12 may be emitting so often that the under-display sensor may detect crosstalk from the emitting display pixels 54 via reflection or back-emission (rather than the ambient environment) even when the under-display sensor 29 is operating during an emission-off period. Accordingly, it may be beneficial to reduce, via the emission duty cycle controller 60, the duty cycle to a second, relatively lower duty cycle to enable the under-display sensor 29 to operate with reduced or minimized crosstalk.

The emission duty cycle controller 60 may adjust the emission duty cycle based on sensor operation data 92 received at the data driver 52. For example, the emission duty cycle controller 60 may reduce the emission duty cycle, receive an indication that the under-display sensor 29 has finished operating, and may increase the duty cycle based on the indication. In other embodiments, the under-display sensor 90 may determine that the emission duty cycle controller 60 has reduced the duty cycle to a desired (e.g., sufficiently low) target emission duty cycle and may operate based on this determination.

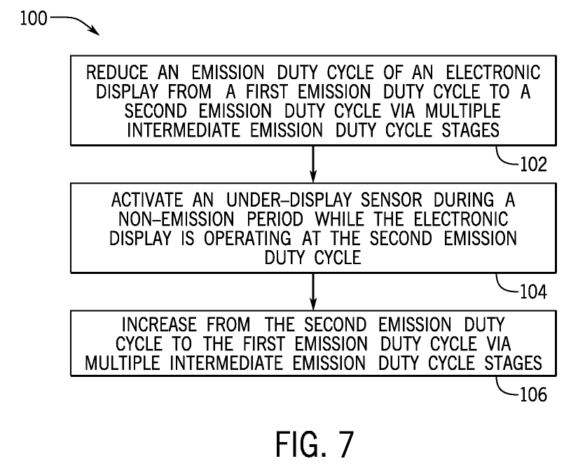

FIG. 7 is a flowchart of a method 100 for adjusting, via the emission duty cycle controller 60, the emission duty cycle of the electronic display 12 to facilitate the operation of the under-display sensor 29. The steps of the method 100 may be performed by the processor core complex 18, the emission duty cycle controller 60, the under-display sensor 29, or any combination thereof. The various components described in FIG. 1, such as the hardware elements (e.g., circuitry), the software elements (e.g., a tangible, non-transitory computer-readable medium storing computer-readable instructions executable by one or more processors), or a combination of both hardware and software elements, may perform the method 100. In process block 102, the emission duty cycle controller 60 may reduce the emission duty cycle by which the electronic display 12 is operating from a first duty cycle to a second duty cycle via multiple intermediate duty cycle stages. The multiple intermediate emission duty cycles may be distributed over multiple image frames. As mentioned above, the first duty cycle may include a normal-operation duty cycle at which the electronic display 12 operates while the under-display sensor 29 is not sensing. The first emission duty cycle may include an emission duty cycle of 70% or higher, 80% or higher, 90% or higher, and so on. The second duty cycle may be lower than the first, resulting in greater emission-off time which may allow the under-display sensor 29 to activate with reduced or minimized crosstalk from the display pixels 54 of the electronic display. The second emission duty cycle may be relatively lower than the first and may include an emission duty cycle of 60% or lower, 50% or lower, 40% or lower, and so on.

In process block 104, the under-display sensor 29 may activate (e.g., perform camera sensing, ambient light sensing, ambient color sensing, and so on) during a non-emission period while the electronic display is operating at the relatively lower second emission duty cycle, such an emission duty cycle of 50%. The under-display sensor 29 may be activated based on reaching the target emission duty cycle (e.g., second emission duty cycle of process block 102). In process block 106, after the under-display sensor 29 has deactivated (e.g., stopped sensing, is in a non-operational period), the emission duty cycle controller 60 may increase the emission duty cycle of the electronic display 12 from the second emission duty cycle to the first emission duty cycle via multiple intermediate emission duty cycle stages. The emission duty cycle controller 60 may determine that the under-display sensor 29 has stopped sensing based on the sensor operation data 92. As will be discussed in greater detail below, the multiple intermediate emission duty cycle stages in the process block 106 may be the same intermediate emission duty cycle stages as described in the process block 102, or may be different.

In some instances, the processor core complex 18 may receive an indication that the emission duty cycle has reduced to a lower emission duty cycle and may cause the under-display sensor 29 to activate based on the electronic display 12 reaching its lower emission duty cycle. Further, in some instances, the processor core complex 18 may deactivate the under-display sensor 29 based on determining that the duty cycle is increasing (e.g., from the second duty cycle to the first duty cycle). In this manner, the method 100 may enable the emission duty cycle controller 60 to adjust the emission duty cycle of the electronic display 12, enabling the under-display sensor 29 to operate with reduced or minimized crosstalk. It should be noted that, while the under-display sensor 29 is described as activating (e.g., operating, turning on, capturing an image, collecting ambient light data, and so on) during the lower emission duty cycle period and deactivating (e.g., ending operation, turning off, refraining from capturing an image, refraining from collecting ambient light data, and so on) during the higher emission duty cycle period, in some embodiments the under-display sensor 29 may be activated at all times, and the data obtained from the under-display sensor 29 may be captured and stored in memory (e.g., nonvolatile memory) only during the lower emission duty cycle period (e.g., when the crosstalk is reduced or minimized).

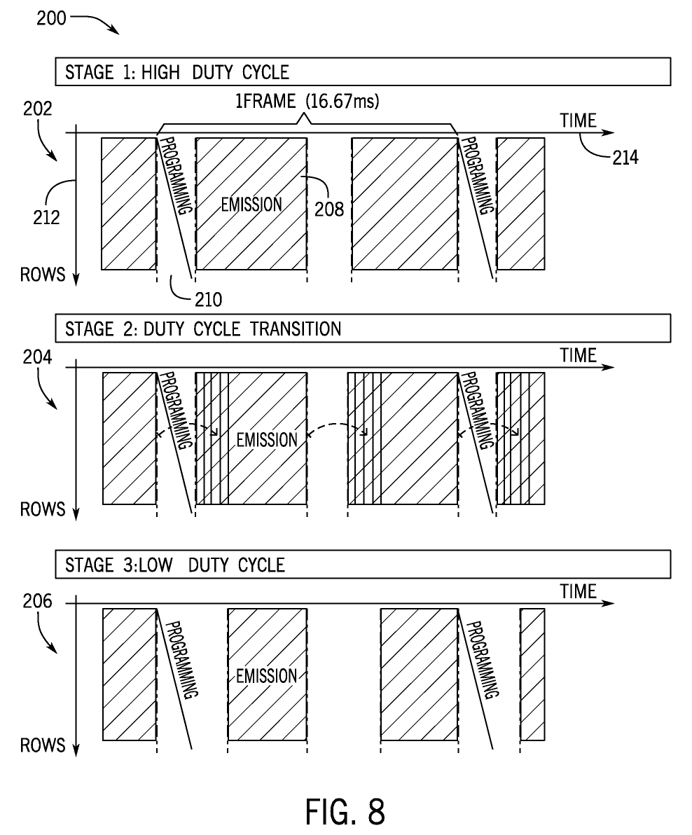

FIG. 8 is a diagram 200 illustrating a transition of the electronic display 12 from a first emission duty cycle (e.g., higher duty cycle) to a second emission duty cycle (e.g., lower duty cycle). The diagram 200 includes a high duty cycle stage 202 (e.g., an initial stage), a transition stage 204, and a low duty cycle stage 206 (e.g., a target stage). The first emission duty cycle stage is referred to as the high duty cycle stage 202 because the duty cycle is greater than the low duty cycle stage 206 (e.g., the second emission duty cycle). Each stage illustrates plots of emission periods 208 and non-emission periods 210 of the electronic display 12. The plots include a y-axis 212 representing the rows of display pixels 54 of the electronic display 12 and an x-axis 214 representing time. The high duty cycle stage 202 may include a duty cycle at which the electronic display 12 operates under normal conditions, such as when the under-display sensor 29 is not operational (e.g., not sensing). As mentioned above, the high duty cycle stage may include an emission duty cycle that is relatively high compared to the low duty cycle stage 206. The high duty cycle stage 202 may include an emission duty cycle of 70% or more, 80% or more, 90% or more, and so on.

The emission duty cycle controller 60 may adjust the emission duty cycle of the electronic display 12 based on receiving an indication (e.g., based on the sensor operation data 92) that the under-display sensor 29 is expected to activate. Upon receiving this indication, the emission duty cycle controller 60 may enter the transition stage 204, where the emission duty cycle controller 60 begins transitioning (e.g., decreasing) the emission duty cycle from the high duty cycle stage 202 to the low duty cycle stage 206. During the transition stage 204, the emission duty cycle controller 60 may walk-down the emission duty cycle by gradually (e.g., progressively) decreasing the emission duty cycle. For example, the emission duty cycle controller 60 may decrease the emission duty cycle by 1% per-frame. That is, if the high duty cycle stage 202 includes an 80% emission duty cycle and the low duty cycle stage 206 includes a 50% emission duty cycle, the emission duty cycle controller 60 may walk down the emission duty cycle by 1% per frame for 30 frames until the low duty cycle stage 206 is reached. While 1% per frame is used as an example, it should be noted that the emission duty cycle controller 60 may walk down the emission duty cycle at a different rate, such as 0.1% per frame or less, 0.2% per frame or less, 0.5% per frame or less, less than 1%, 2% per frame or more, 5% per frame or more, 10% per frame or more, and so on.

Once the low duty cycle stage 206 is reached, the under-display sensor 29 may activate. For example, if the under-display sensor 29 includes an under-display camera, the under-display camera may capture one or more images while the electronic display is operating at the low duty cycle stage 206. In some instances, emission duty cycle controller 60 may be programmed to enter the transition stage 204 again after a set period of time (e.g., a predetermined time in microseconds or milliseconds) that enables the under-display sensor 29 to complete sensing. In some instances, the low duty cycle stage 206 may have been triggered by an application, such as an augmented reality (AR) application, an artificial intelligence (AI) context application, and so on. In these instances, the emission duty cycle controller 60 may hold off on reentering the transition stage 204 until the emission duty cycle controller 60 receives an indication that the application has been exited. In any event, when the emission duty cycle controller 60 is triggered to transition from the low duty cycle stage 206 to the high duty cycle stage 202, the emission duty cycle controller may walk up the duty cycle by gradually (e.g., progressively) increasing the duty cycle. The emission duty cycle controller 60 may walk up the duty cycle at the same rate as the walk down (e.g., 1% per frame) or may do so at a different rate (e.g., 0.1% per frame or less, 0.2% per frame or less, 0.5% per frame or less, less than 1%, 2% per frame or more, 5% per frame or more, 10% per frame or more, and so on).

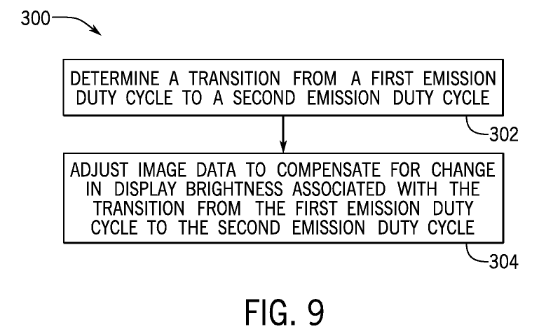

As the electronic display transitions from the higher duty cycle to the lower duty cycle, the average luminance of the electronic display may reduce proportionally—and may increase proportionally when transitioning from the lower duty cycle to the higher duty cycle. To prevent noticeable and undesirable brightness changes to the content displayed on the electronic display, the brightness of the electronic display (e.g., the intensity of the displayed image) may be adjusted to compensate for the change in duty cycle. FIG. 9 is a flowchart of a method 300 for adjusting brightness to compensate for the change in brightness associated with the adjustment of the emission duty cycle as described above. The steps of the method 300 may be performed by the processor core complex 18, the data driver 52, or a combination thereof. The various components described in FIG. 1, such as the hardware elements (e.g., circuitry), the software elements (e.g., a tangible, non-transitory computer-readable medium storing computer-readable instructions executable by one or more processors), or a combination of both hardware and software elements, may perform the method 300. In process block 302, the processor core complex 18 may determine a transition from a first emission duty cycle to a second emission duty cycle. The electronic display 12 may transition between the first emission duty cycle and the second emission duty cycle by decreasing the first emission duty cycle by at least 1% per image frame (e.g., at each intermediate emission duty cycle) until reaching the target second emission duty cycle. The various intermediate emission duty cycles may be distributed over multiple image frames. In process block 304, the processor core complex 18 may adjust the image data 48 to compensate for a change in brightness corresponding to the change in emission duty cycle. The processor core complex 18 may adjust the image data 48 such that the adjusted image data causes content to be displayed on the electronic display 12 to be increasingly brighter for each subsequent frame until the target emission duty cycle is reached. The processor core complex 18 may adjust the image data 48 such that the adjusted image data causes content to be displayed on the electronic display 12 to be increasingly darker for each subsequent frame until the target emission duty cycle is reached. The incremental amount that the brightness is adjusted by responsive to the change in duty cycle may be proportional to the amount of change in duty cycle.

For example, as the emission duty cycle is reduced (e.g., from the high duty cycle stage 202 to the low duty cycle stage 206) the brightness on the electronic display 12 may be reduced. To prevent a noticeable change in display brightness, the gray level of the image data 48 may be proportionally increased. Likewise, as the emission duty cycle is increased (e.g., from the low duty cycle stage 206 to the high duty cycle stage 202) the brightness of the electronic display 12 may be increased. To prevent a noticeable change in display brightness, the gray level of the image data 48 may be proportionally decreased. In this way, the electronic display 12 may adjust (e.g., decrease or increase) the brightness of display pixels 54 to compensate for an change (e.g., increase or decrease) in brightness associated with the transition from the first emission duty cycle to the second emission duty cycle.

As described above, the duty cycle may be progressively walked up or walked down during the transition stage 204. To mitigate noticeable brightness variation, as the duty cycle is stepped down via the emission duty cycle controller 60 from the higher duty cycle to the lower duty cycle, the image data may be adjusted by the processor core complex 18 to proportionally increase the brightness (e.g., gray level) of the displayed image. That is, if the duty cycle is gradually walked down by 1% per frame until the target duty cycle is met, the image data may be brightened by a corresponding gray level value (e.g., 1, 5, 10, 15, and so on) for each subsequent frame to compensate for the decrease in brightness associated with the decreased emission duty cycle. Conversely, the image data may be adjusted to proportionally decrease the brightness as the duty cycle is walked up from the low duty cycle stage 206 to the high duty cycle stage 202 to mitigate noticeable brightness variation, similar to how it is described above with respect to the walking down of the emission duty cycle.

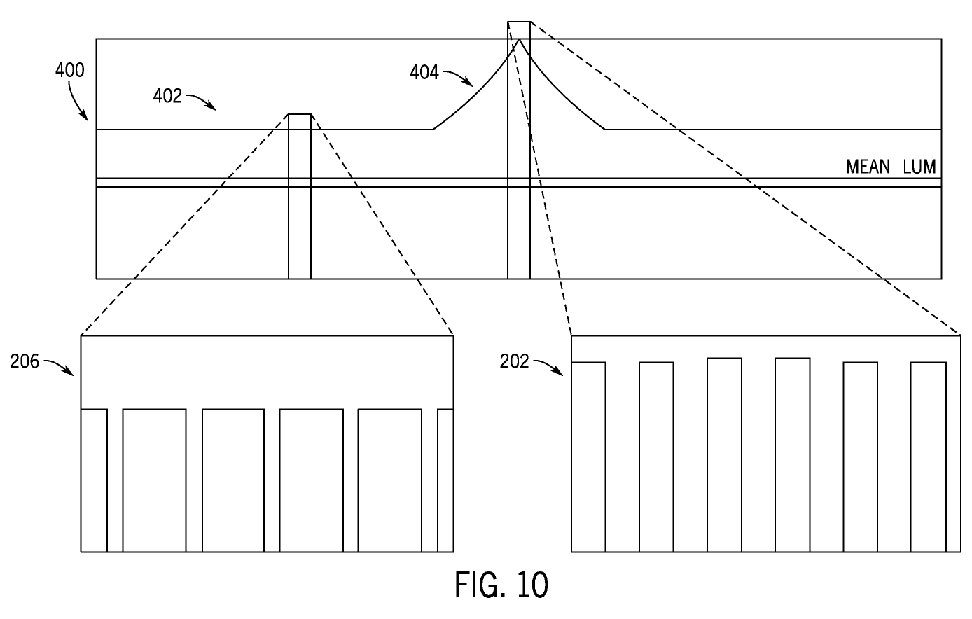

FIG. 10 illustrates a diagram 400 of the luminance of the electronic display 12 during the low duty cycle stage 206 and the high duty cycle stage 202 of the electronic display 12. As may be appreciated, the luminance level 402 may correspond to the low duty cycle stage 206. The luminance level 404 may correspond to the high duty cycle stage 202. As may be appreciated, walking down the duty cycle from the high duty cycle stage 202 to the low duty cycle stage 206 may result in a luminance drop from the luminance level 404 to the luminance level 402. However, adjusting the image data as described with respect to FIG. 9 may mitigate the drop in display brightness associated with the drop from the luminance level 404 to the luminance level 402. Conversely, adjusting the image data as described with respect to FIG. 9 may mitigate the rise in display brightness associated with the rise from the luminance level 402 to the luminance level 404. In this manner, the method 300 of FIG. 9 may reduce or eliminate visible brightness variation associated with transitioning between emission duty cycles.

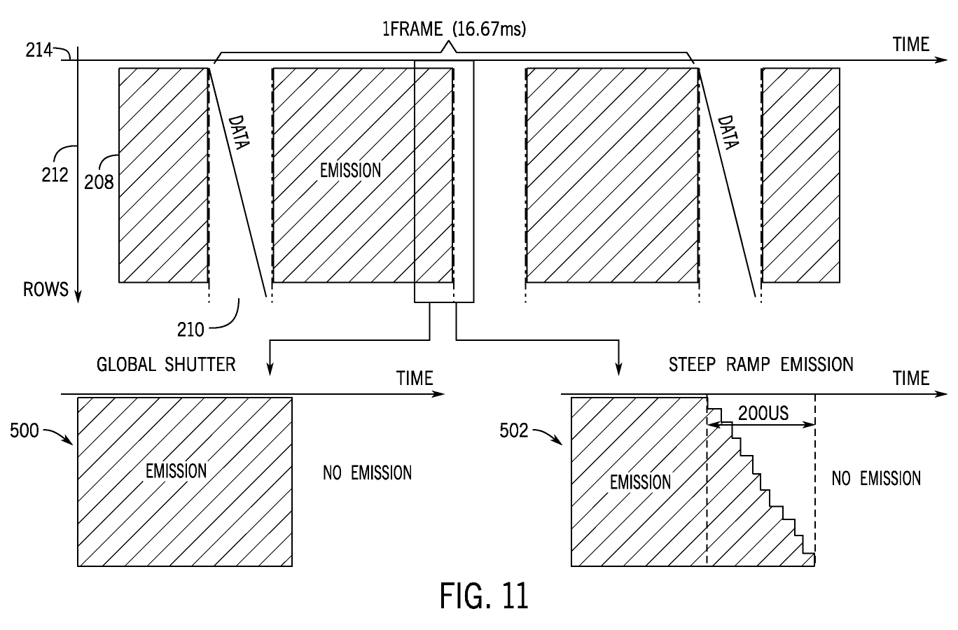

FIG. 11 is a diagram illustrating a global shutter emission scheme and a steep ramp emission (SRE) scheme. FIG. 11 illustrates plots of emission periods 208 and non-emission periods 210 of the electronic display 12. The plots include a y-axis 212 representing the rows of display pixels 54 of the electronic display 12 and an x-axis 214 representing time. In some electronic displays, a rolling emission window may be used to progressively program rows of display pixels (e.g., from top to bottom). However, a rolling emission window may be undesirable for use with the under-display sensor 29, as the rolling emission window may result in at least a portion of the electronic display 12 being illuminated at all times during display of content. Therefore, when using a rolling emission window, there may be no period of time in which sensing via the under-display sensor 29 may be performed without undesirable levels of crosstalk. A global shutter scheme 500 is an emission scheme in which all rows of display pixels 54 are turned on (e.g., illuminated, activated) and off (e.g., deactivated) at the same time. The global shutter scheme 500 may be used to enable the under-display sensor 29 to perform sensing while reducing or eliminating crosstalk, as no display pixels are turned on during the non-emission periods 210. Thus, in some cases, the electronic display 12 may operate at a first emission duty cycle at a first time and transition from the first emission duty cycle to a second emission duty cycle at a second time via one or more intermediate emission duty cycles (e.g., based on operations of method 100, method 300, or both). In such cases, the first emission duty cycle and the second emission duty cycle may include global shutter emission duty cycles during which all display pixels 54 of the electronic display 12 are turned off simultaneously.

However, the global shutter scheme 500 may result in a large transient when all rows of display pixels are turned on or turned off simultaneously. Accordingly, a Steep Ramp Emission (SRE) scheme 502 may be implemented during the transition period from emission periods 208 (e.g., emission-on) to non-emission periods 210 (e.g., emission-off) or vice versa. For the SRE scheme 502, in a first transition period from emission-on to emission-off, the electronic display 12 may gradually (e.g., progressively) turn off the display pixels 54 (e.g., in a monotonic row order). In a second transition period from emission-off to emission-on, the electronic display 12 may gradually turn on the display pixels 54 (e.g., in a monotonic row order) to smooth out the inrush current (e.g., transient current) associated with turning on all display pixels 54 of the electronic display 12 simultaneously. In this manner, SRE scheme 502 may enable the electronic display to be largely, but not completely, globally-off to decrease or minimize under-display sensor 29 crosstalk and to gradually ramp up and ramp down the display pixels 54 to reduce the inrush current associated with transitioning to the emission-on or emission-off periods. Thus, in some cases, the electronic display 12 may operate at a first emission duty cycle at a first time and transition from the first emission duty cycle to a second emission duty cycle at a second time via one or more intermediate emission duty cycles (e.g., based on operations of method 100, method 300, or both). In such cases, the first emission duty cycle and the second emission duty cycle may include ramp emission duty cycles during which different rows of display pixels 54 of the electronic display 12 are turned off or turned on over time, where in some cases a row order by which the rows of the display pixels 54 are turned off or on over time is monotonic.

In some embodiments, the electronic display 12 may not include a global-on or global-off scheme to enable sensing of the under-display sensor 29, but may instead utilize local-on or local-off schemes for a subset of display pixels 54 positioned directly above (e.g., spatially positioned directly above) and/or in the display area surrounding the under-display sensor 29. For example, a subset of the display pixels 54 less than all display pixels 54 of the electronic display 12 may be turned off to enable the under-display sensor 29 to sense with reduced or minimized crosstalk. In this manner, the under-display sensor 29 may sense with reduced or minimized crosstalk and the transient current associated with global-off and global-on emission schemes are reduced or eliminated.

Technical effects of these systems and methods may include reducing or eliminating cross talk associated with the under-display sensor 29 due to emission of the display pixels 54 of the electronic display 12. These systems and methods may also enable display brightness compensation to reduce or mitigate undesired display brightness variation due adjustment of the emission duty cycle. Further, these system and methods may reduce inrush current by implementing an SRE scheme or implementing a local-on or local-off emission scheme.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for

[perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic device comprising:
an electronic display configured to operate at a first emission duty cycle at a first time and transition from the first emission duty cycle to a second emission duty cycle at a second time via a plurality of intermediate emission duty cycles; and
a sensor configured to activate while the electronic display is operating at the second emission duty cycle.

2. The electronic device of claim 1, wherein the sensor comprises a camera, a proximity sensor, an ambient light sensor, or an ambient color sensor, or any combination thereof.

3. The electronic device of claim 1, wherein the electronic display is configured to transition between the first emission duty cycle and the second emission duty cycle by decreasing the first emission duty cycle by at least 1% per image frame.

4. The electronic device of claim 1, wherein the plurality of intermediate emission duty cycles are distributed over a plurality of image frames.

5. The electronic device of claim 1, wherein the first emission duty cycle and the second emission duty cycle comprise global shutter emission duty cycles during which all display pixels of the electronic display are turned off simultaneously.

6. The electronic device of claim 1, wherein the first emission duty cycle and the second emission duty cycle comprise ramp emission duty cycles during which different rows of display pixels of the electronic display are turned off or turned on over time.

7. The electronic device of claim 6, wherein a row order by which the rows of the display pixels are turned off or on over time is monotonic.

8. The electronic device of claim 1, wherein the electronic display is configured to increase brightness of display pixels of the electronic display to compensate for a decrease in brightness associated with the transition from the first emission duty cycle to the second emission duty cycle.

9. The electronic device of claim 1, wherein the electronic display is configured to transition from the second emission duty cycle to the first emission duty cycle after activation of the sensor.

10. The electronic device of claim 9, wherein the electronic display is configured to decrease brightness of display pixels of the electronic display to compensate for an increase in brightness associated with the transition from the second emission duty cycle to the first emission duty cycle.

11. A tangible, non-transitory, computer-readable medium, comprising computer-readable instructions that, when executed by one or more processors, cause the one or more processors to:
provide an initial emission duty cycle for operation of a plurality of display pixels of an electronic display;
transition the initial emission duty cycle through a plurality of intermediate emission duty cycles until a target emission duty cycle is reached; and
activate an under-display sensor based on reaching the target emission duty cycle.

12. The tangible, non-transitory, computer-readable medium of claim 11, wherein executing the instructions causes the one or more processors to transition the initial emission duty cycle by decreasing the initial emission duty cycle by 1% per frame until the target emission duty cycle is reached.

13. The tangible, non-transitory, computer-readable medium of claim 11, wherein executing the instructions causes the one or more processors to adjust image data to be programmed into the plurality of display pixels of the electronic display such that the adjusted image data causes content to be displayed on the electronic display to be increasingly brighter for each subsequent frame until the target emission duty cycle is reached.

14. The tangible, non-transitory, computer-readable medium of claim 11, wherein executing the instructions causes the one or more processors to increase the target emission duty cycle to the initial emission duty cycle after activating the under-display sensor.

15. The tangible, non-transitory, computer-readable medium of claim 14, wherein executing the instructions causes the one or more processors to increase the target emission duty cycle by 1% or less per frame until the initial emission duty cycle is reached.

16. The tangible, non-transitory, computer-readable medium of claim 14, wherein executing the instructions causes the one or more processors to adjust image data to be programmed into the plurality of display pixels of the electronic display such that the adjusted image data causes content to be displayed on the electronic display to be increasingly darker for each subsequent frame until the initial emission duty cycle is reached.

17. The tangible, non-transitory, computer-readable medium of claim 11, wherein the electronic display is configured to program the plurality of display pixels during a global shutter such that the plurality of display pixels are configured to be turned off simultaneously at one time and turned on simultaneously at another time.

18. An electronic display comprising:
a plurality of display pixels configured to emit according to one or more emission duty cycles; and
processing circuitry electrically coupled to the plurality of display pixels and configured to apply a first emission duty cycle to the plurality of display pixels when an under-display sensor is not operating, transition the first emission duty cycle to a second emission duty cycle via a plurality of intermediate duty cycles, and apply the second emission duty cycle to the plurality of display pixels when the under-display sensor is operating.

19. The electronic display of claim 18, wherein the first emission duty cycle is greater than the second emission duty cycle, and the processing circuitry is configured to decrease the first emission duty cycle to the second emission duty cycle for all of the plurality of display pixels.

20. The electronic display of claim 18, wherein the first emission duty cycle is greater than the second emission duty cycle, and the processing circuitry is configured to decrease the first emission duty cycle to the second emission duty cycle for a subset of the plurality of display pixels spatially positioned directly above the under-display sensor.
